(19) United States
(12) Patent Application Publication
(10) Pub. No.: US 2006/0245215 A1
(43) Pub. Date: Nov. 2, 2006

(54) SOCKET WITH PROPER LAMP INSERTION FEATURE AND DUAL FUNCTION BUSHING

(76) Inventors: Anthony Tufano, North Massapequa, NY (US); Emma Levin, Brooklyn, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/380,146

(22) Filed: Apr. 25, 2006

Related U.S. Application Data
(60) Provisional application No. 60/676,273, filed on Apr. 29, 2005.

(51) Int. Cl. H01R 33/00

(52) U.S. Cl. 362/659

(57) ABSTRACT

A lamp holder having oval contact openings to enable an installer to quickly and easily align and insert two contact pins of a single end lamp into the oval contact openings. To further facilitate the insertion of the round contact pins of the lamp into the lamp holder, the oval contact openings have ends which are chamfered. To further facilitate the alignment and insertion of the pins into the contact openings, the long axes of the oval openings are aligned and lie on a common axis. In addition, the lamp holder supports at least two bushings which holds the front and back portions of the lamp holder together and can be used to facilitate the mounting of the lamp holder to a luminaire.

This application claims the benefit of the filing date of a provisional application having Ser. No. 60/676,273 which was filed on Apr. 29, 2005.

### FIELD OF THE INVENTION

The present invention relates to lamp holders.

### BACKGROUND OF THE INVENTION

Modular lamp holders such as those designed to receive single-ended metal halide lamps having a G8.5 base are used in galleries, museums and showrooms to provide indoor accent and display lighting. However, under certain circumstances, installation of a lamp into the lamp holder can be cumbersome. A G8.5 lamp has round contact pins which are inserted into round openings in the lamp holder. Thus, when inserting a G8.5 lamp into a lamp holder, the installer must accurately align the prongs of the lamp with the round openings in the lamp holder to allow the lamp to be connected to the lamp holder. Thus, it may be difficult and time consuming to accurately align the pins of the lamp with the openings in the lamp holder if the person installing the lamp cannot look into the lamp holder when he/she is attempting to insert a G8.5 lamp into a lamp holder. Clearly, a need exists for a lamp holder which will allow a person to more easily and quickly align and insert a lamp, such as a single-ended metal halide lamp having G8.5 base into the lamp holder, particularly when the openings in the lamp holder are not visible.

### SUMMARY OF THE INVENTION

To enable an installer to quickly and accurately align the contact pins of a G8.5 lamp with the contact openings in a lamp holder, there is disclosed contact openings that have an oval shape where the long axes of the two oval contact openings are aligned with each other and lie on a common axis. To further facilitate the insertion of the round contact pins of a G8.5 lamp into the lamp holder, the entrance of the oval contact openings are provided with a generous chamfer. In addition to the new improved oval contact openings having chamfered ends, the housing of the lamp holder is held together with bushings which provide two separate functions. The first is to hold the housing, the lamp holder itself together and the second is to facilitate the mounting of the lamp holder to a luminaire. The bushings can be elongated screws having a head at one end and a threaded portion at the other end. The bushings are fed through clearance openings in the front portion of the lamp holder and the threaded ends of the bushings thread into threaded openings in the back portion of the lamp holder. In another embodiment, the bushings can be rolled over rivets which holds the front and back portions of the lamp holder together and the rear end of the bushings are threaded. The threaded end of the bushings are used to receive threaded mounting screws or bolts from a luminaire.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals:

FIG. 1 illustrates a perspective view of a G8.5 lamp holder showing the oval contact openings in the seat of the lamp holder for receiving the pins of a G8.5 lamp in accordance with the principles of the invention; and

FIG. 2 is a perspective view of the back of the lamp holder.

### DETAILED DESCRIPTION OF PREFERRED EMBODIMENTS

The present invention will now be described more fully hereinafter with reference to the accompanying drawings, in which an embodiment of the invention is shown. This invention may, however, be embodied in many different forms and should not be construed as limited to the embodiment set forth herein. Rather, this embodiment is provided so that this disclosure will be thorough and complete, and will fully convey the scope of the invention to those skilled in the art.

To enable an installer to quickly and easily align and insert the contact pins of a G8.5 lamp into the contact openings in a lamp holder, the contact openings are oval, and the long axis of the two contact openings lie along a common axis. To further facilitate the insertion of the round contact pins of a G8.5 lamp into the contact openings of the lamp holder, the oval contact openings have lead-ins or ends which are chamfered. In addition to the new improved contact openings, the front and back portions of the lamp holder are held together with bushings which have two functions. The first is to hold the two portions of the lamp holder together. The second function is to facilitate the mounting of the lamp holder to a luminaire. The bushings can be elongated screws having a head at one end and a threaded portion at the other end. Each screw is fed through a clearance opening in the front portion of the lamp holder and the threaded end of the screw threads into a threaded opening in the back portion of the lamp holder. Tightening the screws locks the front and back portions of the lamp holder together. In another embodiment, the bushings can be rolled over rivets which hold the front and back portions of the lamp holder together. The ends of the bushings that are accessible from the back portion of the lamp holder can be threaded to receive mounting screws, bolts or the like to permit the lamp holder to be mounted to a luminaire.

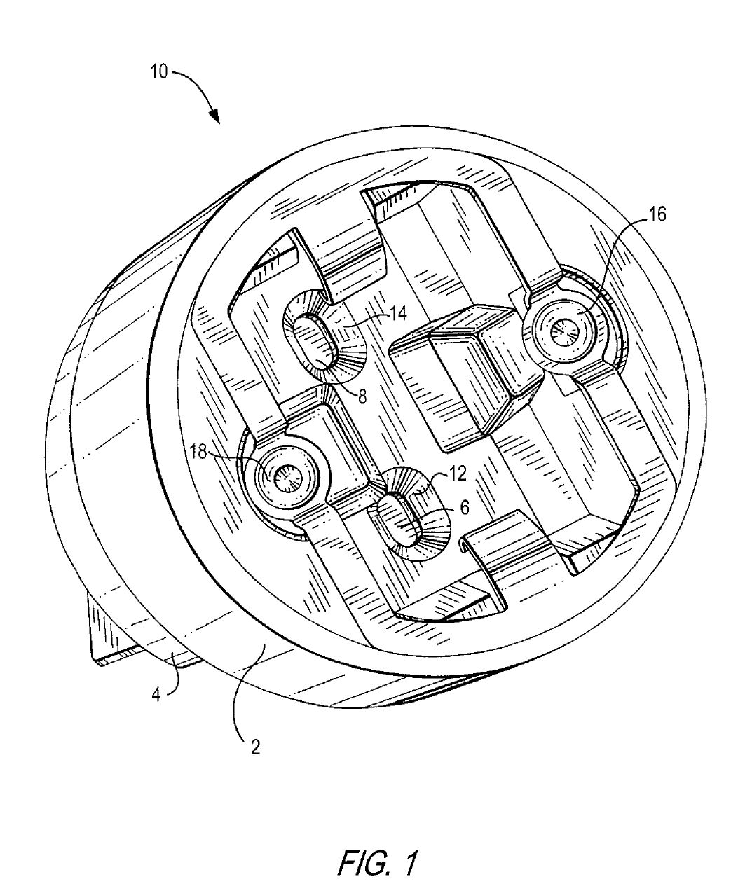

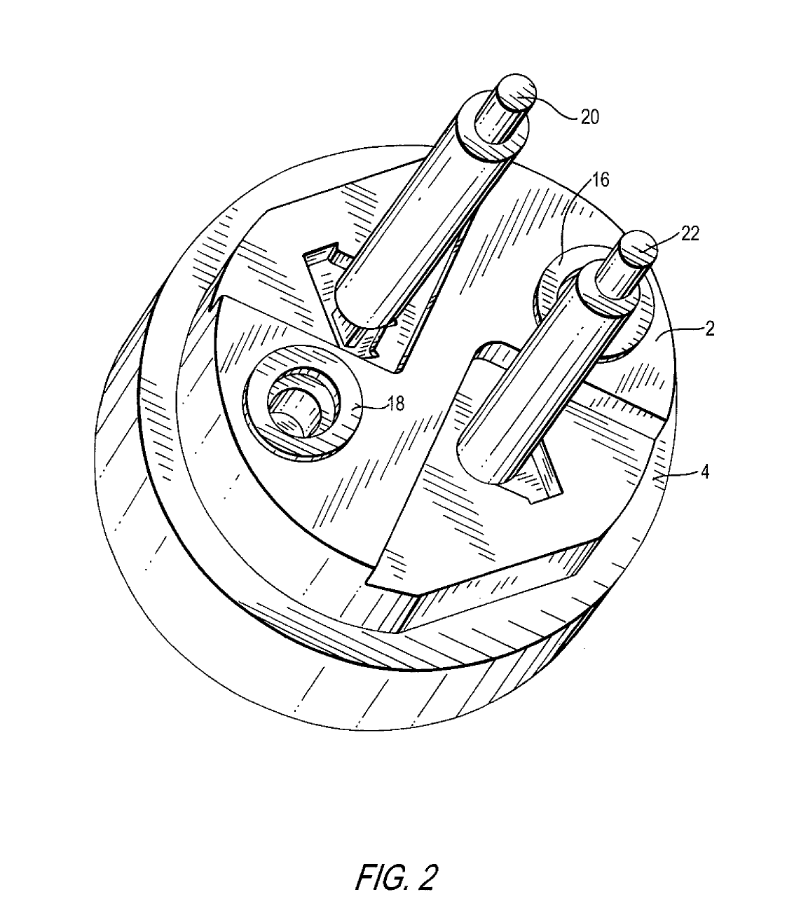

Specifically, as shown in FIG. 1, the lamp holder includes a housing 10 having a front portion 2 and a back portion 4. The front portion 2 includes oval contact openings 6 and 8 for receiving the pins of a G8.5 lamp. Located within the lamp holder and aligned with the oval contact openings 6 and 8 are contacts of brass or the like for receiving the pins of a lamp. The brass contacts within the lamp holder are electrically connected to conductive wires 20, 22, see FIG. 2, which, when connected to a source of electricity, feed power to the contacts in the contact openings in the lamp holder.

Looking at FIG. 1, the oval openings 6 and 8 have chamfered ends 12, 14 which help to position and align the contact pins of a lamp with the contact openings in the lamp holder as a lamp is being inserted into the lamp holder. Each of the oval contact openings and the chamfered ends of the oval contact openings have a long axis and a short axis. The long axis of the oval contact openings and the oval shaped chamfered ends are aligned with each other and lie on a common axis. Roll-over bushings such as screws 16 and 18 which pass through aligned openings in the front and back portions of the housing are used to hold the front 2 and back 4 portions of the housing 10 together. In the alternative, rivets having an end which is threaded to receive a screw may be implemented in the design of the lamp holder 10 in lieu of the screws.

In operation, the contact pins of a G8.5 lamp are positioned over and aligned with the chamfered end oval contact openings in the lamp holder and then connected to the lamp holder by being insert into the oval contact openings 6, 8 by an installer. Compensation for slight misalignment of the contact pins of the lamp with the contact openings in the lamp holder is obtained by contact openings that are oval and where the long axis of the oval contact openings are aligned with each other and lie on a common axis. Additional compensation is obtained by having oval contact openings with chamfered ends.

In addition to the new improved oval contact openings with chamfered ends 6 and 8, the front 2 and back 4 portions of the lampholder 10 are held together with bushings 16 and 18 as shown in FIG. 1. The bushings provide two functions. The first function is to hold the front portion 2 and back portion 4 of the lamp holder together. The second function of the bushing is to connect or mount the lamp holder to a luminaire. The bushings can be elongated screws having a head at one end and a threaded portion at the other end. The threaded end can be inserted into a clearance opening in the front portion 2 of the lamp holder and then threaded into a threaded opening in the back portion 4 of the lamp holder. Tightening the screws locks the front and back portions together.

In another embodiment, the bushings 12 and 14 can be rolled over rivets which hold the front and back portions of the lamp holder together. In this embodiment, the ends of the bushings that are accessible from the back portion of the lamp holder are threaded for receiving mounting screws or bolts to allow the lamp holder to be mounted to a luminaire.

Those skilled in the art will recognize that the physical location of the elements illustrated in FIGS. 1 and 2 can be moved or relocated while retaining the function described above, such as, for example, modifying the location, shape and/or orientation of the oval contact openings and/or oval chamfered ends of the oval contact openings.

While there have been shown and described and pointed out the fundamental novel features of the invention as applied to the preferred embodiments, it will be understood that various omissions and substitutions and changes of the form and details of the method and apparatus illustrated and in the operation may be done by those skilled in the art, without departing from the spirit of the invention.

What is claimed is:

1. A lamp holder comprising:
a housing having a front portion;
at least one pair of contact openings disposed in said front portion;
wherein said contact openings are oval shaped.

2. The lamp holder of claim 1 wherein the long axes of said oval shaped contact openings are aligned with each other and lie on a common axis.

3. The lamp holder of claim 1 wherein said oval shaped contact openings have chamfered ends.

4. The lamp holder of claim 2 wherein said oval shaped contact openings have chamfered ends.

5. The lamp holder of claim 1 further comprising:
at least one pair of bushings which extend through said front portion;
wherein said bushings have threads at one end.

6. The lamp holder of claim 5 further comprising a luminaire coupled to the threaded ends of said bushings.

7. The lamp holder of claim 1 further comprising:
at least one pair of rivets which extend through said front portion;
wherein said rivets have threads at one end for receiving mounting screws.
